(19) United States
(12) Patent Application Publication
(10) Pub. No.: US 2023/0373720 A1
(43) Pub. Date: Nov. 23, 2023

(54) SELF-STORAGE SYSTEM

(71) Applicant: Project DIY, LLC, Dover, DE (US)

(72) Inventor: Royden COOPER, Osprey, FL (US)

(73) Assignee: Project DIY, LLC, Dover, DE (US)

(21) Appl. No.: 17/747,634

(22) Filed: May 18, 2022

(51) Int. Cl. B65G 1/137; E04B 1/348

(52) U.S. Cl. CPC B65G 1/137; E04B 1/34815; B65G 2201/0235

(57) ABSTRACT

Aspects of the present disclosure are directed to a storage system. For example, the storage system can include a storage portion, a plurality of storage modules, and a storage module mover. The storage portion includes an access point, and is partitioned into a maximum number of equal-sized storage areas that fit in the storage portion. The storage modules are stored at respective storage areas within the storage portion. The number of the storage modules is up to the maximum number less 1. The storage module mover is configured to move selected storage modules within the storage portion to the access point of the storage portion.

### TECHNICAL FIELD

The present disclosure relates to systems and methods for providing automated self-storage facilities, and more particularly to a high density self-storage system that can be adapted for use in an existing space.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Self-storage facilities include a number of storage modules that can be located at a single location, which may be indoor, outdoor, or a combination thereof. A typical self-storage facility may have a single story or multiple stories.

### SUMMARY

Aspects of the present disclosure provide a storage system. For example, the storage system can include a storage portion, a plurality of storage modules, and a storage module mover. The storage portion can further include an access point, and be partitioned into a maximum number of equal-sized storage areas that fit in the storage portion. The storage modules are stored at respective storage areas within the storage portion. A number of the storage modules is up to the maximum number less 1. The storage module mover can be configured to move selected storage modules within the storage portion to the access point of the storage portion. In an example, the storage modules can have identical length and width dimensions to one another. As another example, the storage modules can be generally arranged in a two-dimensional matrix within the storage portion.

In an embodiment, the access point can be one of the storage areas that is adjacent to a periphery of the storage portion and allow a user to access the contents of one of the storage modules while the storage module is located at the access point.

In another embodiment, the storage system can further include an access portion that is adjacent to a periphery of the storage portion, the access portion containing the access point and the storage module mover being configured to move the selected storage modules to the access point within the access portion. In a further embodiment, the storage module can include an access door that provides access to an internal portion of the storage module while the storage module is located at the access point within the access portion. In other embodiments, the storage system can further include a staging portion arranged between the storage portion and the access portion, wherein the storage module mover moves the storage modules between the storage portion and the access portion via the staging portion. In various embodiments, the storage areas can be grouped into multiple zones within the storage portion, and the storage module mover can be configured to first complete operations in a current zone before performing any operations in a next zone.

In an embodiment, the storage module mover can be configured to move beneath the storage modules and lift a selected storage module in order to move the selected storage module. For example, the storage module mover can include lift cylinders and a hydraulic power unit that controls the lift cylinders to lift and lower the selected storage module.

In an embodiment, the storage system can further include a receiver configured to receive a select signal that identifies a selected storage module in the storage portion, and a controller that is configured to cause the storage module mover to move the selected storage module to the access point based a unique identifier assigned to each of the storage modules. In another embodiment, the select signal can include a time slot instruction that instructs the controller to cause the storage module mover to move the storage module to the access portion within a requested time slot.

Aspects of the present disclosure also provide a method that can include partitioning a storage portion into a maximum number of equal-sized storage areas that fit in the storage portion, the storage portion including an access point. The method can also include placing a plurality of storage modules at respective storage areas within the storage portion, a number of the storage modules being up to the maximum number less 1. The method can also include instructing a storage module mover to move selected storage modules within the storage portion to the access point of the storage portion.

In an embodiment, the access point can be one of the storage areas that is adjacent to a periphery of the storage portion and allows a user to access the contents of one of the storage modules while the storage module is located at the access point.

In an alternative embodiment, the storage portion can include an access portion that is adjacent to a periphery of the storage portion, the access portion containing the access point, and the storage module mover can be instructed to move selected storage modules to the access point within the access portion. In another embodiment, the storage module can include an access door that provides access to an internal portion of the storage module while the storage module is located at the access point within the access portion. In some other embodiments, the storage portion can include a staging portion between the storage portion and the access portion, and the storage module mover can be instructed to move selected storage modules between the storage portion and the access portion via the staging portion. In various embodiments, the storage areas can be grouped into multiple zones within the storage portion, and moving selected storage modules can include first completing operations in a current zone before performing any operations in a next zone.

In a further embodiment, the storage modules can have identical length and width dimensions to one another. Additionally, the storage module mover can be configured to move beneath the storage modules and lift a selected storage module in order to move the selected storage module.

Note that this summary section does not specify every embodiment and/or incrementally novel aspect of the present disclosure or claimed disclosure. Instead, this summary only provides a preliminary discussion of different embodiments and corresponding points of novelty over conventional techniques. For additional details and/or possible perspectives of the present disclosure and embodiments, the reader is directed to the Detailed Description section and corresponding figures of the present disclosure as further discussed below.

### BRIEF DESCRIPTION OF THE DRAWINGS

Various embodiments of this disclosure that are proposed as examples will be described in detail with reference to the following figures, wherein like numerals reference like elements, and wherein:

FIG. 1 is a schematic diagram of a first exemplary storage system according to some embodiments of the present disclosure;

FIGS. 2 and 3 are schematic diagrams illustrating the operations of the storage system of FIG. 1 according to some embodiments of the present disclosure;

FIG. 3A is a schematic diagram of a second exemplary storage system according to some embodiments of the present disclosure;

FIG. 4 is a schematic diagram of a third exemplary storage system according to some embodiments of the present disclosure;

FIG. 5 is a schematic diagram of a fourth exemplary storage system according to some embodiments of the present disclosure;

FIGS. 6 and 7 are schematic diagrams illustrating the operations of the storage system of FIG. 5 according to some embodiments of the present disclosure;

FIG. 8 is a schematic diagram of a fifth exemplary storage system according to some embodiments of the present disclosure;

FIG. 8A is a schematic diagram of a sixth exemplary storage system according to some embodiments of the present disclosure;

FIG. 9 is a schematic diagram of an exemplary storage module of the storage system according to some embodiments of the present disclosure;

FIG. 10 is a schematic diagram of an exemplary storage module mover of the storage system according to some embodiments of the present disclosure;

FIG. 11 is a functional block diagram an exemplary control system used in the storage system according to some embodiments of the present disclosure; and

FIG. 12 is a flow chart of an exemplary method for providing automated self-storage facilities according to some embodiments of the present disclosure.

### DETAILED DESCRIPTION OF EMBODIMENTS

The word “exemplary” is used herein to mean, “serving as an example, instance or illustration.” Any embodiment of construction, process, design, technique, and the like, designated herein as exemplary is not necessarily to be construed as preferred or advantageous over other such embodiments. Particular quality or fitness of the examples indicated herein as exemplary is neither intended nor should be inferred.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the apparatus (or device) in use or operation in addition to the orientation depicted in the figures. The apparatus (or device) may be otherwise oriented (rotated 90 degrees or at other orientations) and the spatially relative descriptors used herein may likewise be interpreted accordingly.

Conventional storage systems can use space inefficiently. For example, many conventional storage systems require support structures, such as complicated framing and rail infrastructure, to access storage modules. The various support structures take up space within the storage system. Further, many conventional storage systems provide corridors among the storage modules located in a storage space, in order to maintain a pathway in which a storage module can be accessed or moved within the storage system. These pathways or large spaces between the modules also take up space within the storage system that could otherwise be used to hold additional storage modules, and thus the efficiency of the storage system is decreased.

Aspects of the present disclosure provide a high density storage system, e.g., a self-storage system, which requires no supporting infrastructure, such as framework or rails. Operating without supporting structures, the storage system can be installed in a wide variety of spaces or facilities, including purpose-built facilities, abandoned retail centers, warehouses, and the like. According to some embodiments of the present disclosure, the storage modules and a storage module mover are designed such that the storage module mover can travel below the storage modules. Therefore, a density of the storage modules, i.e., net rentable square footage to gross floor area, within the facility can be greatly increased, as corridors are not required between the storage modules, and the storage space can be used most efficiently. The efficiency can be defined as net rentable square footage/gross floor area. For example, a traditional self-storage facility usually has around 75% efficiency while the present disclosure allows for 90%+ efficiency.

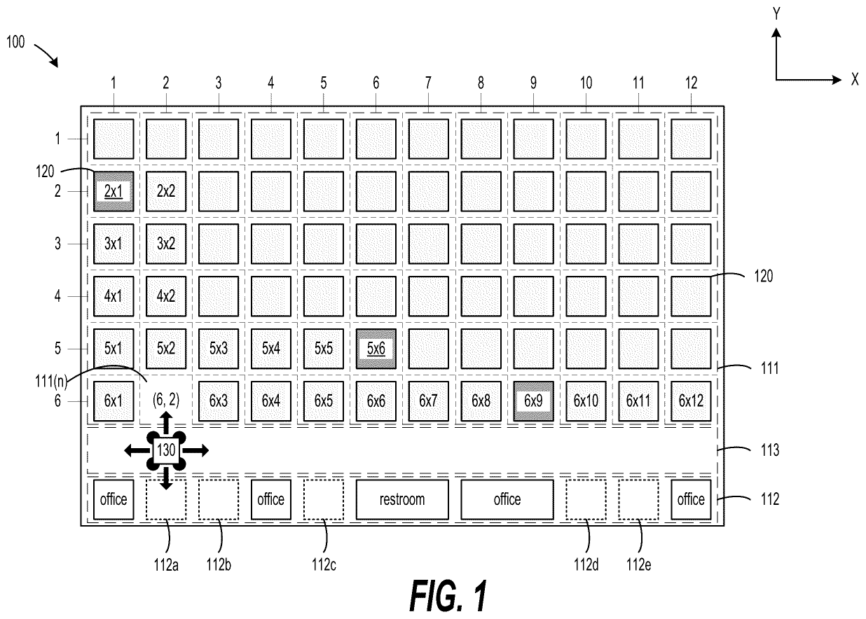

FIG. 1 is a schematic diagram of an exemplary storage system (or self-storage system) 100 according to some embodiments of the present disclosure. The storage system 100 can include a storage portion 111, an access portion 112 and a staging portion 113 that are shown in FIG. 1 as a top-down view of a floor area.

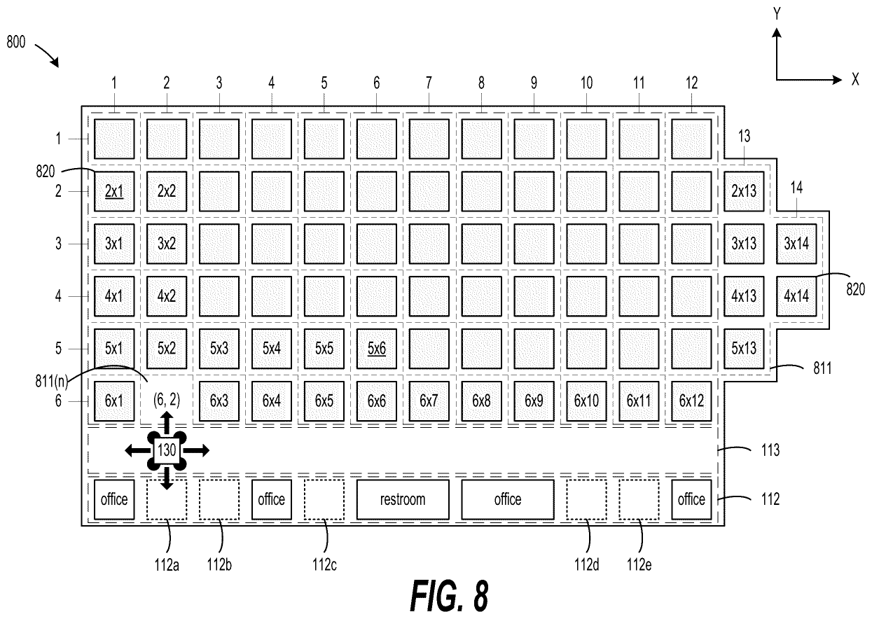

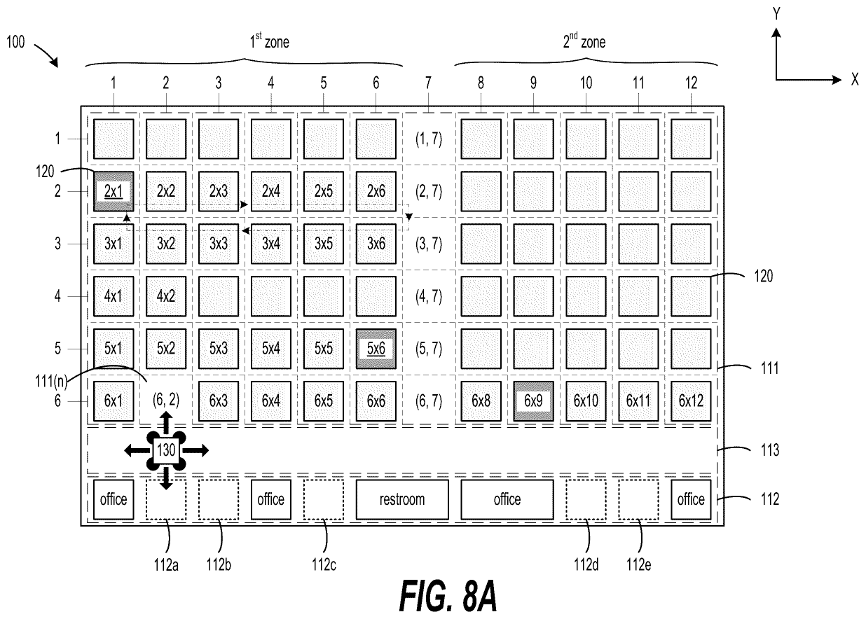

The storage portion 111 stores storage modules 120 and can be partitioned into a maximum number of storage areas 111(n) that fit in the storage portion 111. The storage areas 111(n) correspond to positions within the storage portion 111 where the storage modules 120 can reside. In an embodiment, the storage areas 111(n) can be arranged in a two-dimensional matrix. For example, the matrix can have 6 rows and 12 columns, and the storage portion 111 can be partitioned into 6×12=72 storage areas 111(n), which can be indexed by coordinates (1, 1), (1, 2), . . . , (1, 12), (2, 1), . . . , (6, 1), . . . and (6, 12), respectively. Of course, it should be understood that the arrangement of the storage areas 111(n) is not limited to a two-dimensional matrix and that many configurations are possible. The storage portion 111 can be any shape (as shown in FIG. 8) and can be partitioned into storage areas 111(n) in order to conform and maximize the number of storage areas 111(n) that fit in the storage portion 111.

The storage portion 111 includes an access point. In an embodiment, for example, the access point can be one of the storage areas 111(n) that is adjacent to a periphery of the storage portion 111. In operation, a selected storage module 120 can be moved within the storage portion 111 to the access point, which allows a user to access the contents of the selected storage module 120 while the storage module 120 is located at the access point.

In an embodiment, the storage system 100 can further include the access portion 112 having one or more access portals for users to access selected storage modules 120 that have been retrieved from the storage portion 111. For example, the access portion 112 can include five access portals 112a to 112e. In an embodiment, the number of the access portals 112a to 112e is a design choice that can be a function of the number of storage modules 120 and the other system requirements. As required, the access portion 112 can also house other facilities, such as custom private lobbies, blocks of storage lockers, restrooms, and the like.

In some embodiments, the storage system 100 can include the staging portion 113 as a space that is arranged between the storage portion 111 and the access portion 112. The staging portion 113 can serve as the space to move or stage a storage module 120 from the storage portion 111 to the access portion 112. For example, selected storage modules 120 can be moved from the storage portion 111 through the staging portion 113 to the access portion 112 where a user can then access the contents of the storage module 120.

As described above, the storage system 100 can further include a plurality of storage modules 120 that are placed at respective storage areas 111(n) within the storage portion 111. In an embodiment, the storage modules 120 can all have the same dimensions. For example, the storage modules 120 have equal lengths, widths, and heights. Further, each of the storage modules 120 can have a unique identifier associated therewith for retrieval and other purposes. For example, each storage module 120 may have a RFID device built into the storage module, a marking, such as a barcode or QR code located on the storage module, or any other technique for identifying the storage module 120 may be used.

In a preferred embodiment, the number of storage modules 120 that are stored in the storage portion 111 is equal to the maximum number of the storage areas 111(n) that can fit in the storage portion 111 less one. For example, the storage system 100 shown in FIG. 1 can include a maximum number of 72 storage areas 111(n) (i.e., 6×12=72). Therefore, the preferred number for storage modules 120 in this embodiment is 71 (i.e., 72−1=71). For referencing purposes, the locations of the storage modules 120 within the storage portion 111 can be indexed by 1×1, 1×2, . . . , 1×12, 2×1, 6×1, 6×3, 6×4, . . . and 6×12, respectively, and can be referenced as being placed in the storage areas (1, 1), (1, 2), . . . , (1, 12), (2, 1), . . . , (6, 1), (6, 3), (6, 4), . . . and (6, 12), respectively. As shown in this example, the storage area (6, 2) is unoccupied.

The storage system 100 can further include a storage module mover 130 that functions to retrieve requested storage modules 120 from the storage portion 111 and deliver the storage module 120 to the access portion 112. Further, the storage module mover 130 can function to move or shuffle any of the storage modules 120 as necessary to retrieve a requested storage module 120. While in a preferred embodiment only a single storage module mover 130 is required, of course it should be understood other embodiments can include multiple storage module movers 113 that operate in conjunction with one another.

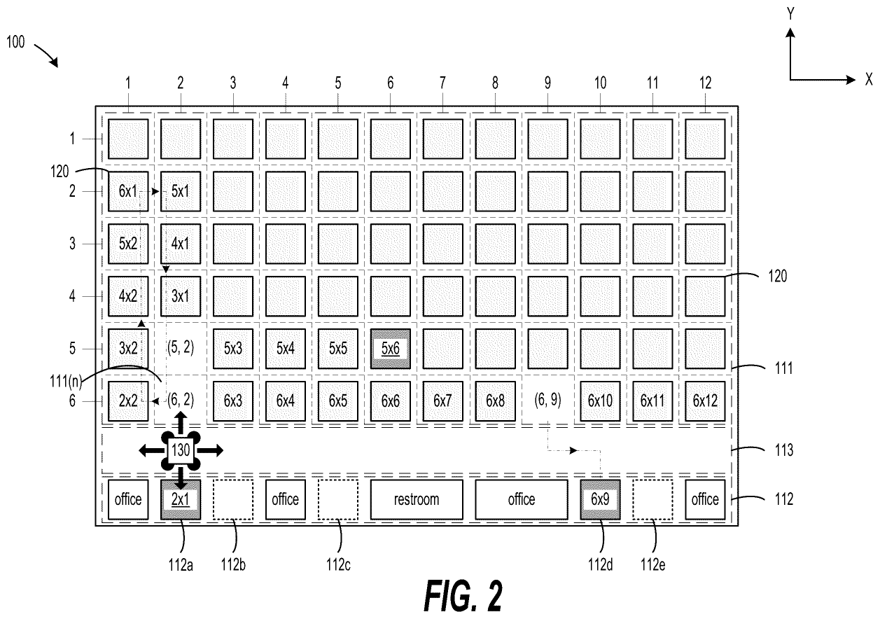

In the example of operation shown in FIG. 2, in response to a user request, the storage module mover 130 can move the storage module 6×9, which is located at the periphery of the storage portion 111 to the staging portion 113, i.e., the storage area (6, 9), from the storage portion 111 through the staging portion 113 to the access portal 112d of the access portion 112 leaving the storage area (6, 9) unoccupied. Once the user finishes accessing the storage module 6×9, the storage module mover 130 can move the storage module 6×9 back to any one of the storage areas 111(n) of the storage portion 111. In this example, the storage module mover 130 can return the storage module 6×9 to the storage area (6, 9), which is its original storage area and is the nearest one of all the unoccupied storage areas 111(n), i.e., the storage areas (6, 2) and (6, 9), to the access portal 112d.

In a more complicated example of operation, a user requests access to the storage module 2×1. In this instance, because the storage module 2×1 is not located on the neighboring edge of the storage portion 111 to the access portion 112, the storage module mover 130 has to further move or shuffle the storage modules 2×2, 3×2, 4×2, 5×2, 6×1, 5×1, 4×1 and 3×1, which are located between the storage module 2×1 and the staging portion 113, in order to clear a path for the storage module 2×1 from its storage area (2, 1) to the staging portion 113. In an embodiment, the storage module mover 130 can move the storage modules 5×2, 4×2, 3×2, 2×2, 2×1, 3×1, 4×1, 5×1 and 6×1 sequentially clockwise, as shown in FIG. 2, or move the storage modules 6×1, 5×1, 4×1, 3×1, 2×1, 2×2, 3×2, 4×2 and 5×2 sequentially counterclockwise, until no storage module 120 is located between the storage module 2×1 and the staging portion 130, and then move the storage module 2×1 from the storage portion 111, e.g., at the storage area (5, 2), through the staging portion 113 to the access portal 112a. After the user finishes accessing the storage module 2×1, the storage module mover 130 can return the storage module 2×1 to the storage area (6, 2), which is the nearest unoccupied cell of the storage areas 120 to the access portal 112a.

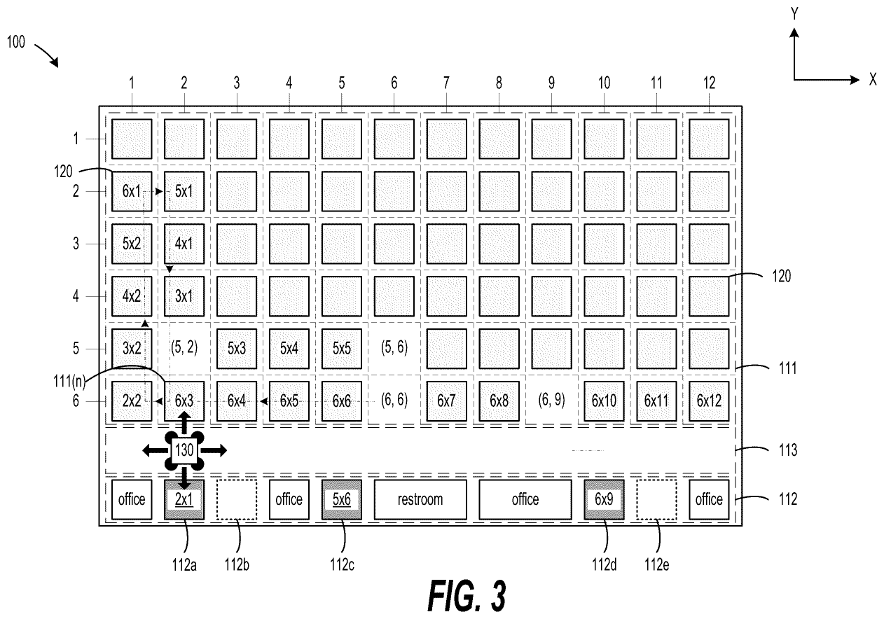

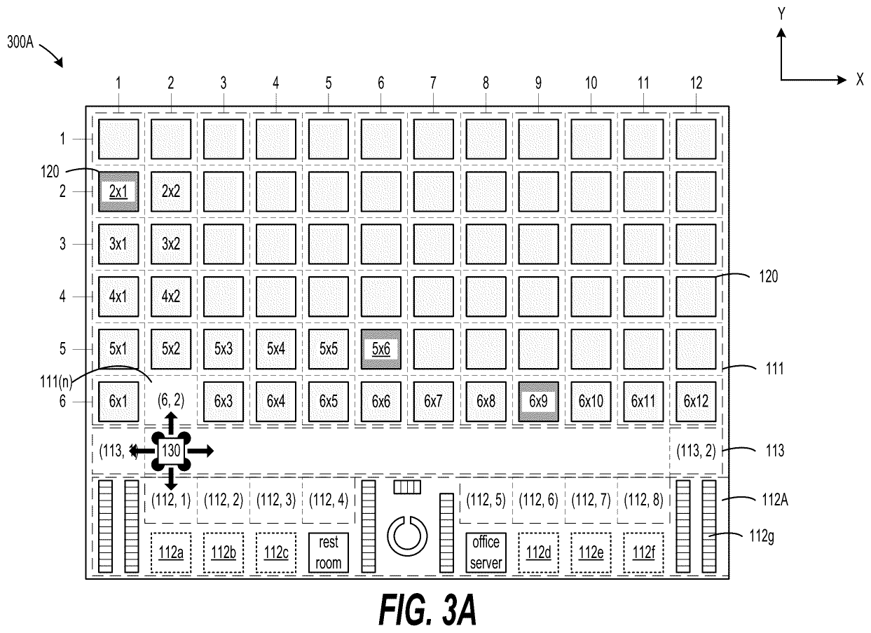

In yet another example shown in FIG. 3, when the user is still accessing the storage module 2×1, which is located at the access portal 112a, leaving the storage area (6, 2) still unoccupied, and the storage module 5×6 is selected, the storage module mover 130 can move the storage modules 6×3, 6×4, 6×5 and 6×6 one storage area leftward sequentially, and then move the storage module 5×6 from the storage portion 111 through the staging portion 113 to the access portal 112c. In this scenario, when the user finishes accessing the storage module 2×1, the storage module mover 130 can move the storage module 2×1 to the storage area (6, 6), which is unoccupied now, or can move the storage module 6×3 one storage area upward, leaving unoccupied the storage area (6, 2), which is the nearest one of the storage areas 111(n) to the access portal 112a, and then move the storage module 2×1 to the unoccupied storage area (6, 2).

In operation, and as necessary for efficiency, a given proportion of the access portals 112a to 112e can be used as short term storage areas. Accordingly, some of the storage modules 120 are to be placed in the staging portion 113, further adding to a density of the storage system 100.

FIG. 3A is a schematic diagram of an exemplary storage system 300A according to some embodiments of the present disclosure. The storage system 300A differs from the storage system 100 in that the storage system 300A includes more storage areas. For example, in addition to the storage areas 111(n) that the storage system 100 includes, the storage system 300A further includes storage areas (113, 1) and (113, 2), which are located in the staging portion 113, and storage areas (112, 1) to (112, 8), which are located in an access portion 112A. The storage system 300A can further include access portals 112a to 112f and a plurality of lockers 112g. In an embodiment, the access portion 112A can contain the access point.

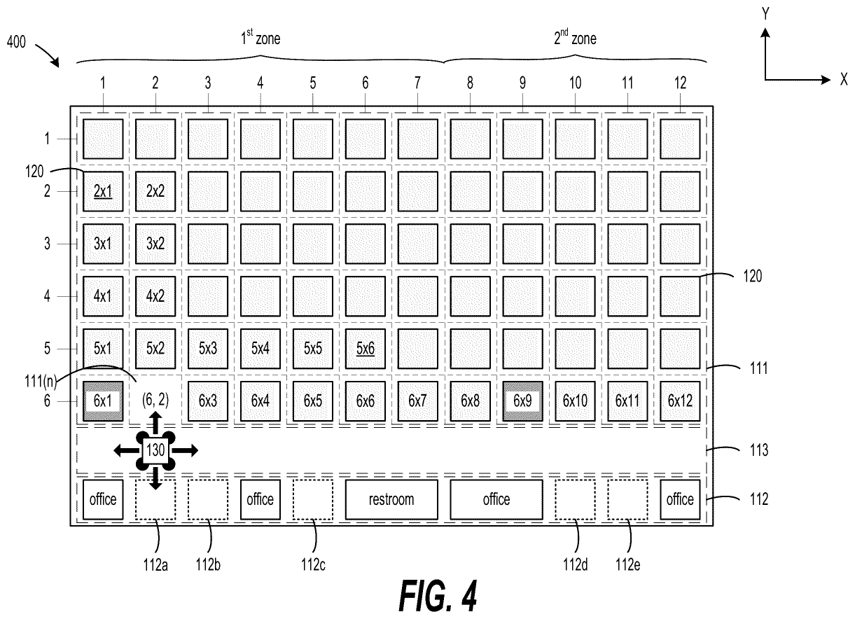

FIG. 4 is a schematic diagram of another exemplary storage system 400 according to some embodiments of the present disclosure. The storage system 400 differs from the storage system 100 in that in the storage system 400 the storage areas 111(n), and the access portals 112a to 112e as well, are divided into a plurality of zones. For example, the 6×12=72 storage areas 111(n), and the access portals 112a to 112e as well, can be divided into a first zone and a second zone. In an embodiment, the first zone and the second zone can include different numbers of storage areas 111a. For example, the first zone includes 6×7=42 storage areas 111(n) and the corresponding access portals 112a to 112c, and the second zone includes 6×5=30 storage areas 111(n) and the corresponding access portals 112d and 112e. In another embodiment, the first zone and the second zone can include equal storage areas 111(n).

In the storage system 400, in order to prevent the storage module mover 130 from traveling back and forth between the first zone and the second zone, as well as save time and power consumed by the storage module mover 130, whenever the storage module mover 130 is in one of the first and second zones, e.g., the first zone, and there is at least one of the storage modules 120 in the first zone that still needs to be moved, the storage module mover 130 will stay in the first zone and move the storage module 120 to one of the access portals 112a to 112c, even when there is another one of the storage modules 120 located in the second zone that is selected before the storage module 120 in the first zone is selected. In other words, the storage module mover 130 is configured to first complete operations in a current zone before performing any operations in a next zone.

For example, in the storage system 400 when the storage module mover 130 is in the first zone and the storage module 6×9 located in the second zone is selected, the storage module mover 130 should have been traveling to the second zone to move the storage module 6×9 to one of the access portals 112d and 112e, e.g., the access portal 112d; however, when the storage module mover 130 is traveling on its way to the second zone, but still in the first zone, the storage module 6×1 is being selected. In this scenario, the storage module mover 130 is configured to travel to the storage area (6, 1) where the storage module 6×1 is placed, and move the storage module 6×1 to one of the access portals 112a to 112c first, and then travel to the second zone and move the storage module 6×9 to the access portal 112d.

As another example, when the storage module mover 130 is staying in the first zone and there are two of the storage modules 120 in the first zone that are selected, the storage module mover 130 can move one of the selected storage modules 120 that is selected first to the staging portion 113, move the other of the selected storage modules 120 to one of the access portals 112a to 112c first, e.g., the access portals 112a, and move the first selected storage module then to another one of the access portals 112a to 112c, e.g., the access portal 112b.

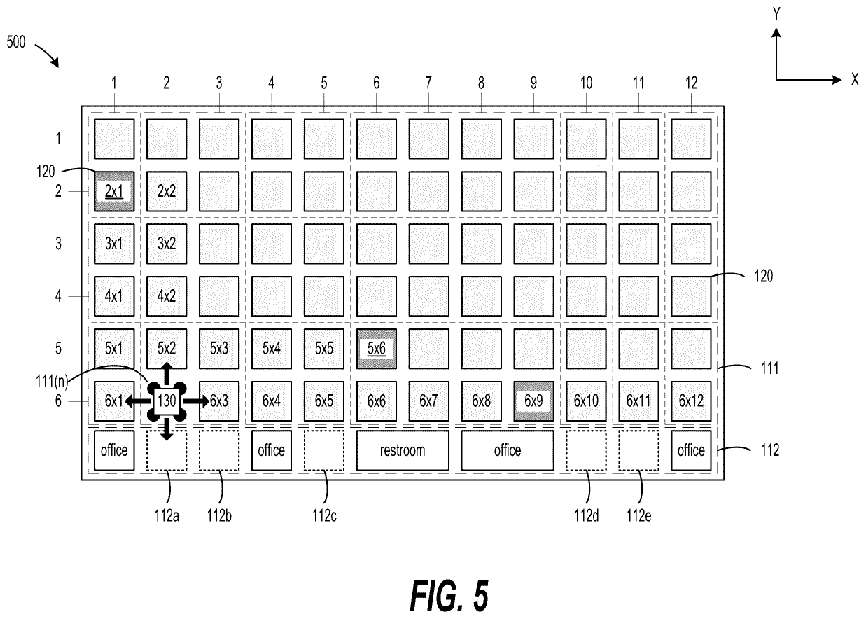

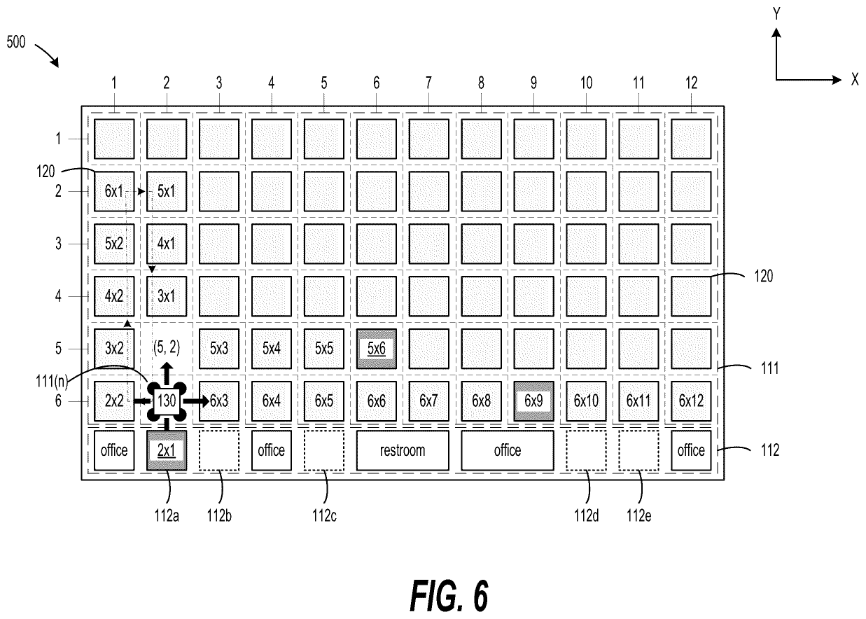

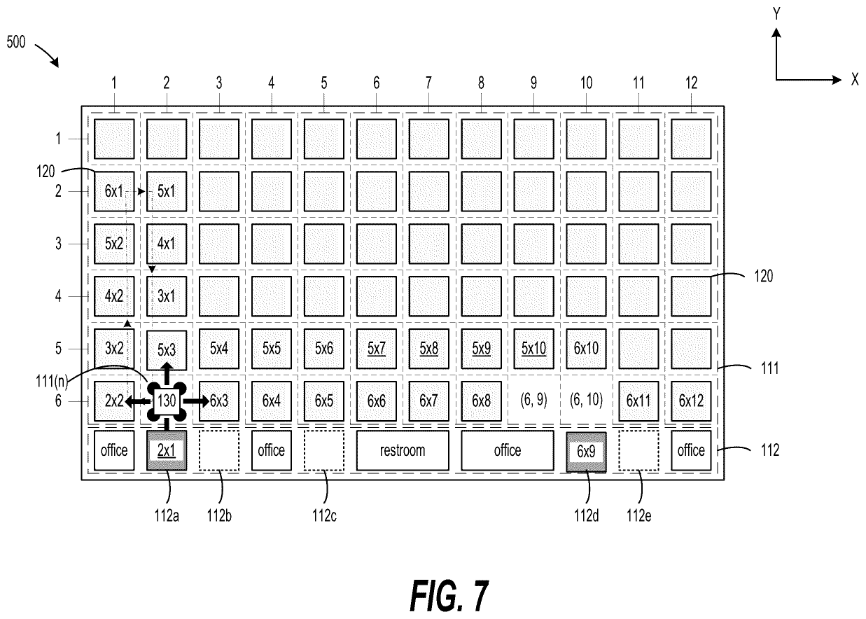

FIG. 5 is a schematic diagram of yet another exemplary storage system 500 according to some embodiments of the present disclosure. The storage system 500 differs from the storage system 100 in that in the storage system 500 the staging portion 113 is omitted, leaving the storage portion 111 neighboring the access portion 112, to further increase the storage density. In an embodiment, the access point can be the storage area (6, 2). In operation, for example, in the storage system 500 the storage module mover 130 can move the storage module 2×1 from the storage portion 111 to the access portal 112a directly, leaving the storage area (5, 2) unoccupied, as shown in FIG. 6 and described previously by reference to FIG. 2. As another example, in the storage system 500 the storage module mover 130 can move the storage modules 5×3, 5×4, 5×5, 5×6, 5×7, 5×8, 5×9, 5×10, 6×10 and 6×9 sequentially counterclockwise, and then move the storage module 6×9 to the access portal 112d, leaving the storage area (5, 2) occupied by the storage module 5×3 and the storage areas (6, 9) and (6, 10) unoccupied, as shown in FIG. 7.

FIG. 8 is a schematic diagram of yet another exemplary storage system 800 according to some embodiments of the present disclosure. The storage system 800 differs from the storage system 100 in that in the storage system 800 a storage portion 811 is partitioned into a maximum number of equal-sized storage areas 811(n) that fit in the storage portion 811, but is not arranged in a two-dimensional matrix. For example, in addition to the storage areas (1, 1), (1, 2), . . . , (1, 12), (2, 1), . . . , (6, 1), (6, 3), (6, 4), . . . and (6, 12), the storage portion 811 can further include storage areas (2, 13), (3, 13), (3, 14), (4, 13), (4, 14) and (5, 13), which can be occupied by storage modules 2×13, 3×13, 3×14, 4×13, 4×14 and 5×13, respectively. In the example embodiment, each of the storage areas 811(n) neighbors another one of the storage areas 811(n) with two sides thereof. In some other embodiments, at least one of the storage areas 111(n) can neighbor another one of the storage areas 811(n) with only one side thereof. In such a scenario, the number of storage modules 820 of the storage system 800 is up to the maximum number of the storage areas 811(n) less two. In the storage system 800, the staging portion 113 can also be omitted.

FIG. 8A is a schematic diagram of yet another exemplary storage system 800A according to some embodiments of the present disclosure. The storage system 800A differs from the storage system 400 in that the first zone of the storage system 800A includes 6×6=36 storage areas 111(n), leaving the storage areas (1, 7) to (6, 7) unoccupied. Therefore, instead of moving the storage modules 5×2, 4×2, 3×2, 2×2, 2×1, 3×1, 4×1, 5×1 and 6×1 sequentially clockwise, as shown in FIG. 2, the storage module mover 130 can move the storage modules 2×6, 2×5, 2×4, 2×3, 2×2, 2×1, 3×1, 3×2, 3×3, 3×4, 3×5 and 3×6 sequentially clockwise until moving the storage module 2×1 to the storage area (2, 7), and then move the storage module 2×1 to the access portal 112a.

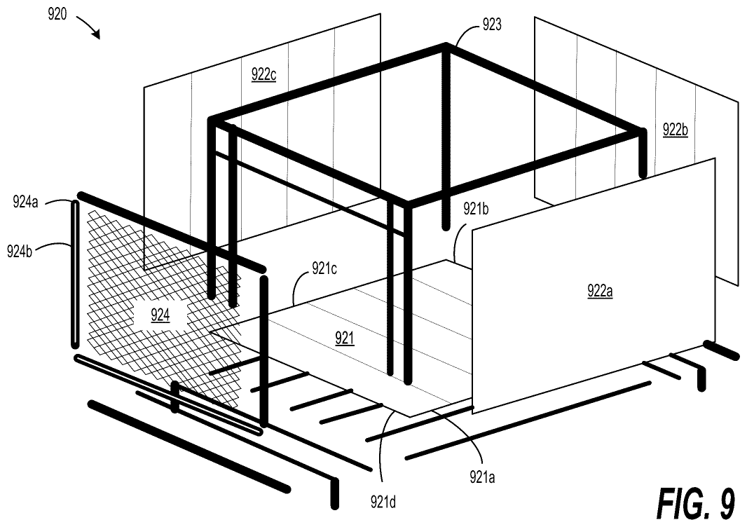

FIG. 9 is an exemplary schematic diagram of a storage module 920 according to some embodiments of the present disclosure. For example, the storage module 920 can be standardized on a 10′×10′ footprint, however, it should be understood that the storage module 920 can be made to any dimensions based on design requirements. This standardization makes the density possible. In an embodiment, the storage module 920 can include a leg plate 921, first to third wall connection plates 922a to 922c, a series of lateral elements (e.g., rods, pipes, etc.) 923 that fix the first to third wall connection plates 922a to 922c to first to third edges 921a to 921c of the leg plate 921, and an access door 924 that is installed on a fourth edge 921d of the leg plate 921 and is moveable up and down. The configuration of the storage module 920 provides a rigid lifting point and allows the necessary space below the storage module 920 to accommodate and be engaged by the storage module mover 130.

In an embodiment, the top of the storage module 920 can be open or screened to permit overhead lighting in the access portion 112 and sprinkler while being in the storage portion 111. In another embodiment, the fourth wall of the storage module 920 can be framed with corner frames forming an opening, e.g., 8′×8′, and four guide rails 924a can be mounted on door frames 924b accommodating a horizontally mounted chain link “door,” e.g., the access door 924, which will be raised as a portal door installed at each of the access portals 112a to 112e when opened. Guides mounted on the ends of the chain link will act to maintain the “door” in the guide rails 924a when closed. In an embodiment, the access door 924 can be a meshed access door. In some other embodiments, the floor on the leg plate 921 can include floor pans captured between the wall connection plates 922a to 922c. In another embodiment, fiber reinforced cement can be poured over the floor pans, providing a stable walking surface.

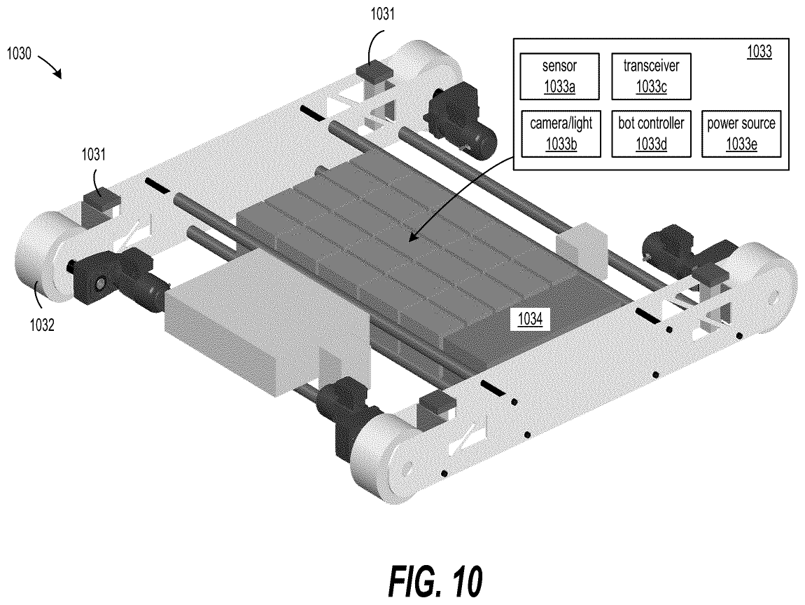

FIG. 10 is a schematic diagram of a storage module mover 1030, according to an exemplary embodiment of the present disclosure. For example, the storage module mover 1030 can include lift cylinders 1031 and a hydraulic power unit 1034 that controls the lift cylinders 1031 to lift and lower the selected storage module 120. The storage module mover 1030 has a profile low enough to allow itself to travel beneath the storage module 920, and to lift, move, and lower the storage module 920 with the lift cylinders 1031. For example, the lift cylinders 1031 can lift the storage module 930 vertically upwards, for example, 25 mm. The storage module mover 130 can further include wheels 1032. For example, the wheels 1032 can include omni-directional wheels, allowing the storage module mover 1030 to travel within the storage portion 111, the staging portion 113 and the access portion 112 and move the storage modules 120 between the storage portion 111 and the access portion 112, regardless of their positions in the storage portion 111. The omni-directional wheels 1032 can be driven by well-known drive systems, such as electric motors with or without a transmission system. As another example, the wheels 1032 can be controlled to allow the storage module mover 1030 to travel on two axes, e.g., X-axis and Y-axis, laterally and longitudinally or rotate, within the storage portion 111, the access portion 112 and the staging portion 113.

In an embodiment, the storage module mover 1030 can be implemented as a bot, which can further include integral control electronics 1033. For example, the integral control electronics 1033 can include one or more sensors 1033a (e.g., AV sensors, such as cameras, proximity sensors, IR sensors, LiDAR sensors, light sensors, and the like) and camera/light 1033b configured to detect nearby objects and obstacles autonomously. Orientation and positioning of the storage module mover 1030 can be achieved via four commercially standard distance lasers, one on each of the four directions (e.g., X+, X−, Y+ and Y−, or N, S, E and W).

The integral control electronics 1033 can further include a wireless transceiver (or receiver) 1033c configured to receive wireless control signals, and a bot controller 1033d coupled to the transceiver 1033c, the camera/light 1033b and the sensors 1033a and configured to control the operations of the transceiver 1033c, the camera/light 1033b and the sensors 1033a. Therefore, the storage module mover 1030 can be programmed with instructions for causing the storage module mover 1030 to travel in the storage spaces 110 and 810 in order to move, shuffle, and retrieve selected storage modules as instructed. The integral control electronics 1033 can further include a power source 1033e, e.g., an onboard battery, configured to provide power to the bot controller 1033d, the transceiver 1033c, the camera/light 1033b and the sensors 1033a and any other components of the storage module mover 1030 as well.

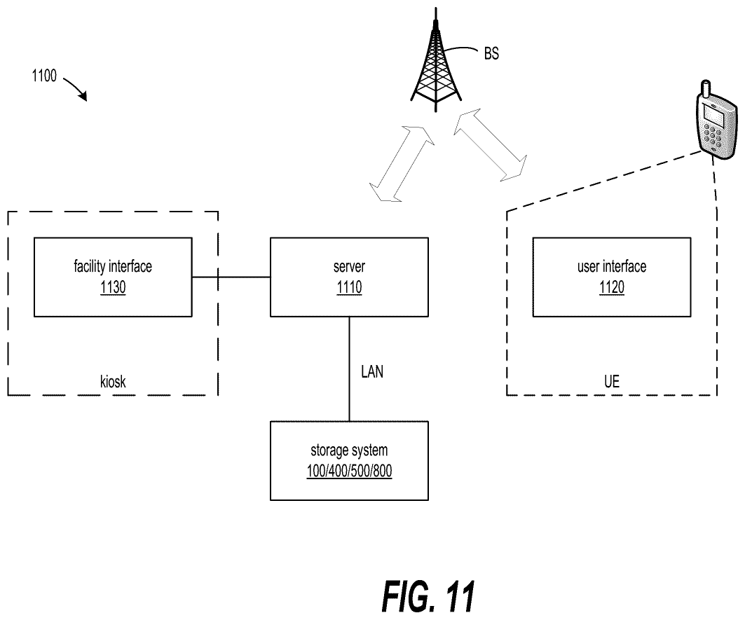

FIG. 11 is a functional block diagram of an exemplary control system 1100 used in a storage system, e.g., the storage systems 100, 300A, 400, 500, 800 and 800A, according to embodiments of the present disclosure. The control system 1100 can include a computer or processor that executes programming stored on a non-transitory computer readable medium that causes the computer or processor to perform the operations of the control system. For example, the control system 1100 can include a user interface 1120, which can be implemented as an application running on user equipment (UE). In an embodiment, each of the storage modules 120 and 820 is assigned with a unique identifier. The user is allowed to select one or more of the storage modules 120 and 820 via the app running on his UE. For example, the user can log in with their ID and password to open the app and schedule a time slot, such as a 30 minute long window, to access their respective storage module.

The control system 1100 can further include a server 1110, which can be coupled to the UE wirelessly via, for example, a radio communication network architecture. After authenticating the user, the server 1110 can control the storage system 100/300A/400/500/800/800A to move one or more of the storage modules 120 and 820 that have identifiers corresponding to the user's ID, for example, to the access portion 112 within the requested time slot.

The control system 1100 can further include a facility interface 1130 coupled to the server 1110 in a wired or wireless manner. In an embodiment, the facility interface 1130 can be installed on a kiosk. When the user arrives at the kiosk and logs in with their ID and password on the facility interface 1130, the facility interface 1130 will show in which access portal(s) their storage module(s) are placed. Then the user can walk to the access portal(s) to access an internal portion of the storage module(s) via the access door(s).

A radio communication network architecture, such as a Long Term Evolution (LTE) system, an LTE-Advanced (LTE-A) system, an LTE-Advanced Pro system, or a 5G NR RAN may typically include at least one base station (BS), at least one UE, and one or more optional network elements that provide connection within a network. The UE may communicate with the network such as a Core Network (CN), an Evolved Packet Core (EPC) network, an Evolved Universal Terrestrial RAN (E-UTRAN), a Next-Generation Core (NGC), a 5G Core (5GC), or an internet via a RAN established by one or more BSs. However, the scope of the present disclosure is not limited to these protocols.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, a Personal Digital Assistant (PDA) with wireless communication capability, and the like. The UE may be configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic Wideband-Code Division Multiple Access (W-CDMA), High-Speed Packet Access (HSPA), LTE, LTE-A, evolved/enhanced LTE (eLTE) that is LTE connected to 5GC, NR (often referred to as 5G), and/or LTE-A Pro. However, the scope of the present disclosure is not limited to these protocols.

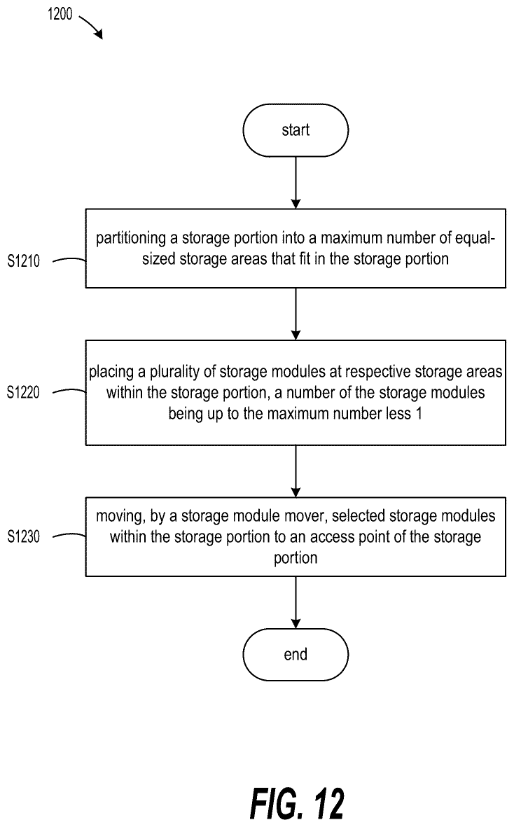

FIG. 12 is a flow chart of an exemplary method 1200 for providing automated self-storage facilities according to an embodiment of the present disclosure. In various embodiments, some of the steps of the method 1200 shown can be performed concurrently or in a different order than shown, can be substituted by other method steps, or can be omitted. Additional method steps can also be performed as desired. Aspects of the method 1200 can be implemented by a storage system, such as the storage system 100/300A/400/500/800/800A illustrated in and described with respect to the preceding figures.

At step S1210, a storage portion can be partitioned into a maximum number of equal-sized storage areas that fit in the storage portion. For example, the storage portion 111 can be partitioned into a maximum number (6×12) of equal-sized storage areas 111(n) that fit in the storage portion 111.

At step S1220, a plurality of storage modules can be placed at respective storage areas within the storage portion, the number of the storage modules being up to the maximum number less 1. For example, 72−1=71 storage modules 120 can be placed at respective storage areas 111(n) within the storage portion 111.

At step S1230, a storage module mover can move selected storage modules within the storage portion to an access point of the storage portion. For example, the storage module mover 130 can move selected storage modules 120 within the storage portion 111 to an access point of the storage portion 111.

In an embodiment, the access point is one of the storage areas that is adjacent to a periphery of the storage portion and allows a user to access the contents of one of the storage modules while the storage module is located at the access point. For example, the access point can be the storage area (6, 2), which is adjacent to the periphery of the storage portion 111.

In an embodiment, the method 1200 can further include providing an access portion that is adjacent to a periphery of the storage portion, the access portion containing the access point, wherein moving selected storage modules includes moving the selected storage modules to the access point within the access portion. For example, the access portion 112 is adjacent to the periphery of the storage portion 111, as shown in FIG. 5, the access portion 112 contains an access point that is the storage area (112, 1), as shown in FIG. 3A, and the storage module mover 130 can move the selected storage modules 120 to the access point (120, 1) within the access portion 112.

In another embodiment, the storage module includes an access door that provides access to an internal portion of the storage module while the storage module is located at the access point within the access portion. For example, the storage module 920 can include the access door 924, which provides access to the internal portion of the storage module 920. In some other embodiments, a staging portion can be further arranged between the storage portion and the access portion, and the selected storage modules can be moved between the storage portion and the access portion via the staging portion. For example, the staging portion 113 can be arranged between the storage portion 111 and the access portion 112, and the storage module mover 113 can move the storage modules 120 between the storage portion 111 and the access portion 112 via the staging portion 113. In various embodiments, the storage areas can be grouped into multiple zones within the storage portion, and the selected storage modules can be moved such that operations in a current zone are completed first before performing any operations in a next zone. For example, in the storage system 400 when the storage module mover 130 is in the first zone and the storage module 6×9 located in the second zone is selected, the storage module mover 130 is configured to travel to the storage area (6, 1) where the storage module 6×1 is placed, and move the storage module 6×1 to one of the access portals 112a to 112c first, and then travel to the second zone and move the storage module 6x9 to the access portal 112d.

In an embodiment, the storage modules have identical length and width dimensions to one another. In another embodiment, the storage module mover is configured to move beneath the storage modules and lift a selected storage module in order to move the selected storage module.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A storage system, comprising:
a storage portion including an access point, the storage portion being partitioned into a maximum number of equal-sized storage areas that fit in the storage portion;
a plurality of storage modules that are stored at respective storage areas within the storage portion, a number of the storage modules being up to the maximum number less 1; and
a storage module mover configured to move selected storage modules within the storage portion to the access point of the storage portion.

2. The storage system of claim 1, wherein the access point is one of the storage areas that is adjacent to a periphery of the storage portion and allows a user to access the contents of one of the storage modules while the storage module is located at the access point.

3. The storage system of claim 1, further comprising an access portion that is adjacent to a periphery of the storage portion, the access portion containing the access point and the storage module mover being configured to move the selected storage modules to the access point within the access portion.

4. The storage system of claim 3, wherein the storage module includes an access door that provides access to an internal portion of the storage module while the storage module is located at the access point within the access portion.

5. The storage system of claim 3, further comprising:
a staging portion arranged between the storage portion and the access portion,
wherein the storage module mover moves the storage modules between the storage portion and the access portion via the staging portion.

6. The storage system of claim 5, wherein the storage areas are grouped into multiple zones within the storage portion, and the storage module mover is configured to first complete operations in a current zone before performing any operations in a next zone.

7. The storage system of claim 1, wherein the storage modules have identical length and width dimensions to one another.

8. The storage system of claim 1, wherein the storage module mover is configured to move beneath the storage modules and lift a selected storage module in order to move the selected storage module.

9. The storage system of claim 8, wherein the storage module mover includes lift cylinders and a hydraulic power unit that controls the lift cylinders to lift and lower the selected storage module.

10. The storage system of claim 1, further comprising:
a receiver configured to receive a select signal that identifies a selected storage module in the storage portion; and
a controller that is configured to cause the storage module mover to move the selected storage module to the access point based a unique identifier assigned to each of the storage modules.

11. The storage system of claim 10, wherein the select signal includes a time slot instruction that instructs the controller to cause the storage module mover to move the storage module to the access portion within a requested time slot.

12. The storage system of claim 1, wherein the storage modules are generally arranged in a two-dimensional matrix within the storage portion.

13. A method of storing storage modules, comprising:
partitioning a storage portion into a maximum number of equal-sized storage areas that fit in the storage portion, the storage portion including an access point;
placing a plurality of storage modules at respective storage areas within the storage portion, a number of the storage modules being up to the maximum number less 1; and
instructing a storage module mover to move selected storage modules within the storage portion to the access point of the storage portion.

14. The method of claim 13, wherein the access point is one of the storage areas that is adjacent to a periphery of the storage portion and allows a user to access the contents of one of the storage modules while the storage module is located at the access point.

15. The method of claim 13, wherein the storage portion includes an access portion that is adjacent to a periphery of the storage portion, the access portion containing the access point, and the storage module mover is instructed to move selected storage modules to the access point within the access portion.

16. The method of claim 15, wherein the storage module includes an access door that provides access to an internal portion of the storage module while the storage module is located at the access point within the access portion.

17. The method of claim 15, wherein the storage portion includes a staging portion between the storage portion and the access portion, and the storage module mover is instructed to move selected storage modules between the storage portion and the access portion via the staging portion.

18. The method of claim 17, wherein the storage areas are grouped into multiple zones within the storage portion, and moving selected storage modules includes first completing operations in a current zone before performing any operations in a next zone.

19. The method of claim 13, wherein the storage modules have identical length and width dimensions to one another.

20. The method of claim 13, wherein the storage module mover is configured to move beneath the storage modules and lift a selected storage module in order to move the selected storage module.
